(19) United States
(12) Patent Application Publication
(10) Pub. No.: US 2025/0235779 A1
(43) Pub. Date: Jul. 24, 2025

(54) BUTTON AND CONTROLLER FOR GAME

(71) Applicant: ELECOM CO., LTD., Osaka (JP)

(72) Inventors: Kiyotaka HIRATA, Osaka (JP); Atsuki TABETA, Osaka (JP)

(21) Appl. No.: 19/027,613

(22) Filed: Jan. 17, 2025

(30) Foreign Application Priority Data
Jan. 22, 2024 (JP) 2024-007540

(51) Int. Cl. A63F 13/24

(52) U.S. Cl. CPC A63F 13/24

(57) ABSTRACT

To provide a button and a controller for a game in which the stroke width of the button member can be easily adjusted by replacing the fixing ring. A button used for a controller for a game, comprising a push switch built in a housing of the controller, a button member connected to the push switch, and a fixing ring supporting the button member, wherein the fixing ring is removably provided to the housing, and a stroke width of the button member can be adjusted through replacement of the fixing ring.

### TECHNICAL FIELD

The present invention relates to a button for a game controller used in video games, etc. and to a controller for a game.

### BACKGROUND ART

The following buttons have been proposed for a controller for a game.

For example, Patent Literature 1 (Japanese Patent Laid-Open No. 2018-160343), discloses an operation switch comprising a proximity switch part with a proximity switch and an actuator that operates the proximity switch can easily replace the proximity switch parts or the actuator at a low cost. An operation switch.

In the operation switch described in Patent Literature 1, one or more actuators are separable to the proximity switch section with a common insertion side attachment/removal mechanism corresponding to the receiving side attachment/removal mechanism of the proximity switch section, and the proximity switch of the proximity switch section can perform common switching operations for switching operations by the one or more actuators The proximity switches of the proximity switch section are capable of performing common switching operations for switching operations by one or more actuators.

Patent Literature 2 (Japanese Patent Laid-Open No. 2020-047386) discloses a push-button switch device that reduces the number of parts and man-hours required to connect the wiring-side terminals.

The push switch is composed of a connecting case portion integrally provided at the lower end of the switch case, a plurality of male-type switch-side terminals hanging in the connecting case portion, an insertion portion removably inserted into the connecting case portion, a plurality of female-type wiring-side terminals connected to external wiring and accepting the plurality of switch-side terminals when the insertion portion is inserted into the connecting case portion, and a means for locking the wiring-side terminals when the wiring-side terminals are attached to the switch-side terminals. The locking means comprises: a plurality of female wiring side terminals that are connected to external wiring and that detachably accept the plurality of switch side terminals when the insertion part is inserted into the connecting case section; and a locking means that locks the wiring side terminals when they are attached to the switch side terminals, and the locking means comprises: a fixed engagement protrusion provided on the connecting case side and a fixed engagement protrusion provided on the insertion part that is pivotable on the insertion part and that is fixed on the connecting case side. The locking means is composed of a fixed locking projection provided on the connecting case side and a movable locking member provided on the insertion part side that engages with the fixed locking projection when the insertion part is inserted into the connecting case section.

Patent Literature 3 (Japanese Patent Laid-Open No. 2019-125439) discloses a pushbutton switch that can suppress the impact sound generated both when the pushbutton member is pushed down and when the pushbutton member returns to its original position after the pushdown is released, with a simple configuration.

The push button switch described in Patent Literature 3 has a cylindrical case body, a push switch with an auto-return switch knob attached to the bottom plate of the case body, and a push button member attached to the switch knob of the push switch and slidable in the vertical direction against the case body. The push button member is attached to the switch knob of the push switch and slidable in the vertical direction against the case body. The push button member is composed of an elastomer resin or the like having cushioning and elasticity, a push operation part, a mounting sleeve with a mounting hole on the lower side of the push operation part for press-fitting the switch knob, and a contact part located on the outer side of the mounting sleeve for regulating the descent width of the push button member. The pushbutton member is located on the outer side of the mounting sleeve and is in contact with the mounting sleeve.

### CITATION LIST

### Patent Literature

Patent Literature 1: Japanese Patent Laid-Open No. 2018-160343

Patent Literature 2: Japanese Patent Laid-Open No. 2020-047386

Patent Literature 3: Japanese Patent Laid-Open No. 2019-125439

### SUMMARY OF INVENTION

### Technical Problem

In recent years, home video game consoles have become widely popular, and controllers for a game center can be used with home video game consoles when playing fighting or shooting games.

In fighting or shooting games, where quicker and more precise button inputs are needed, the user may adjust the stroke width of the buttons to suit him or her.

In conventional controllers, when adjusting the stroke width of a button, it is necessary to disassemble and modify the button member and/or switch parts, or replace the button member and/or switch parts, which is costly and difficult to disassemble.

The operation switch of the Patent Literature 1 allows easy and low-cost replacement of proximity switch parts or actuators, but the stroke width of the button is not easily adjustable.

In the push button type switch of the Patent Literature 2, the locking means when the wiring side terminal is attached to the switch side terminal consists of a fixed fastening protrusion on the connecting case side and a movable fastening member that engages the insertion portion with said fixed fastening protrusion.

This reduces the number of parts and man-hours required for connection, but the stroke width of the buttons cannot be easily adjusted.

In the push-button switch of the Patent Literature 3, by changing the material of the push-button member to elastomer, it is possible to suppress the impact and continuous hitting sound generated when the contact part of the push-button member hits the stepped part on the bottom plate of the case body, but the stroke width of the button is not easily adjustable.

Therefore, an object of the present invention is to provide a button and a controller for a game in which the stroke width of the button member can be easily adjusted by replacing the fixing ring.

### Solution to Problem

(1)

A button according to one aspect is a button which is used for a controller for a game, the button comprising: a push switch built in a housing of the controller; a button member connected to the push switch; and a fixing ring supporting the button member, wherein the fixing ring is removably provided to the housing, and
a stroke width of the button member can be adjusted through replacement of the fixing ring.

Since the fixing ring is removable from the housing, the stroke width of the button can be adjusted by replacing the fixing ring. As a result, modification or disassembly of buttons or switch components to adjust the stroke width of the button is not necessary.

Therefore, by changing the fixing ring, the stroke width of the switch can be easily adjusted to suit the user's preference.

(2)

A button according to a second invention is the button according to the one aspect, wherein the button member has a leg portion which is brought into contact with a base plate fixed to the housing when a pressing operation is executed, the fixing ring has a skirt portion which is brought into contact with the leg portion when the button member is released from the pressing operation, and the stroke width of the button member can be adjusted through replacement of the fixing ring with a fixing ring having a different length of the skirt portion from a length of the skirt portion of the fixing ring.

When a pressing operation is performed, the leg portions of the button member make contact with the base plate fixed to the housing, thereby limiting the pressing distance of the switch and preventing the switch from breaking down.

On the other hand, when the button member is released from pressing operation, the skirt portion contacts the leg portions, thereby restricting the uppermost position of the button member. Therefore, different lengths of the skirt portion of the fixing ring will change the stroke width of the button member.

This allows the stroke width of the button member to be adjusted by changing the fixing ring with a longer skirt portion and the fixing ring with a shorter skirt portion. Therefore, by changing to a fixing ring with a different skirt portion length, the stroke width of the button member can be easily adjusted according to user preferences.

(3)

A button according to a third invention is the button according to the one aspect or the second invention, wherein the push switch is a depth sensor and a depth of a reaction point of the push switch can be adjusted.

Since the fixing ring limits the height of release of the button member, if a fixing ring with a small stroke width (a fixing ring with a long skirt portion) is used and the reaction point of the push switch is fixed at a shallow position, it may not function as a switch. The button of the third invention does not have such a problem because the depth of the reaction point can be adjusted.

(4)

A button according to a fourth invention is the button according to from the one aspect to the third invention, wherein the fixing ring has a tapered portion continuously provided to the skirt portion, and the tapered portion abuts an edge portion of an attachment hole of the housing to which the fixing ring is fitted.

This allows the tapered portion connected to the skirt portion of the fixing ring to be accurately positioned with respect to the attachment hole in the housing. Since the fixing ring is precisely positioned with respect to the attachment hole, the clearance (gap) between the button member and the fixing ring can be designed to a minimum. Therefore, the wobble of the button member can be suppressed when pressing operation is performed.

On the other hand, since the fixing ring is positioned by the tapered portion and the outer diameter of the skirt portion is designed to be smaller than the inner diameter of the attachment hole, a space can be provided between the attachment hole of the housing and the skirt portion of the fixing ring. Thus, the fixing ring can be made into a button that can be easily replaced.

(5)

A button according to a fifth invention is the button according to from the one aspect to the fourth invention, wherein the button member has four leg portions

This prevents instability in pressing operation, even when the button is operated vigorously and pushed in strongly, since the four leg portions make contact with the base plate fixed to the housing when the pressing operation is performed.

(6)

A controller for a game according to another aspect is a controller for a game comprising a button according to from the one aspect to the fifth invention.

This allows the controller for a game to be adjusted for stroke width by replacing the fixing ring.

(7)

A controller for a game according to a seventh invention is the controller for a game according to the another aspect, wherein a plurality of the buttons are provided and a different depth of a reaction point can be set for each button.

This allows the depth of the reaction point to be set for each button, even when multiple buttons with different stroke widths are placed on a controller for a game.

(8)

The controller for a game according to an eighth invention is the controller for a game according to from the another aspect to the seventh invention, wherein a top plate of the housing is replaceable.

This allows a user to customize the controller to suit their preferences by replacing the top plate.

### BRIEF DESCRIPTION OF DRAWINGS

FIG. 1 is a perspective view illustrating an example of a controller for a game.

FIG. 2 is a schematic exploded view of the button to illustrate the relationship of the arrangement of each button member.

FIG. 3 is a schematic view illustrating a shape of the fixing ring.

FIG. 4 is a schematic perspective view illustrating a button member.

FIG. 5 is a schematic cross-sectional view illustrating a state in which the components of FIG. 2 are combined.

FIG. 6 is a schematic diagram illustrating the case where the button member is released from pressing operation and the case where the button is pressed.

FIG. 7 is a schematic view illustrating a relationship between the length of the skirt portion and the stroke width.

FIG. 8 is a schematic view illustrating an example of a relationship between button position and push switch output.

FIG. 9 is a schematic flowchart illustrating an example of a program to adjust the depth of the reaction point of a button.

### DESCRIPTION OF EMBODIMENT

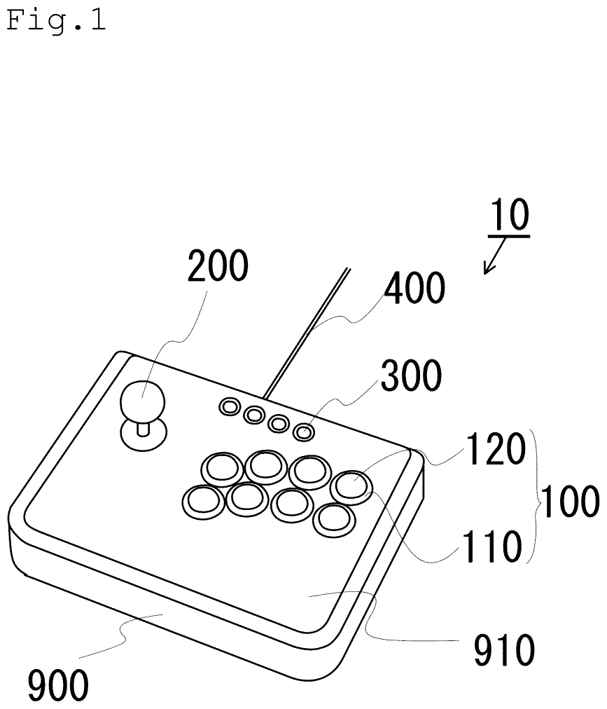

FIG. 1 is a perspective view of an example of a controller for a game 10 in the present embodiment.

As shown in FIG. 1, the controller for a game 10 comprises button 100, USB cable 400, control lever 200, and other control switches 300 in a housing 900, and the housing 900 is equipped with a top plate 910 of the housing.

The housing 900 is rectangular in shape, and a plurality of buttons 100 are attached to the surface of the housing 900 in a curved shape to correspond to a person's fingers. The shape and material of the housing 900 are not limited in the present Embodiment.

To use the controller for a game 10, connect the USB plug of the USB cable 400 that the housing 900 has to the USB port of a gaming device or a personal computer.

The housing 900 of the present embodiment is equipped with a control lever 200 that can be tilted in any direction. The housing 900 may also be equipped with a decorative LED or other device for each of the buttons 100.

The user can play the game by operating the plurality of buttons 100 and control levers 200 located on the housing 900.

A removable top plate 910 is attached to the surface of the housing 900, and the top plate 910 can be removed and a top plate 910 of any design can be attached to make the controller designed according to user preferences.

### 100 Buttons

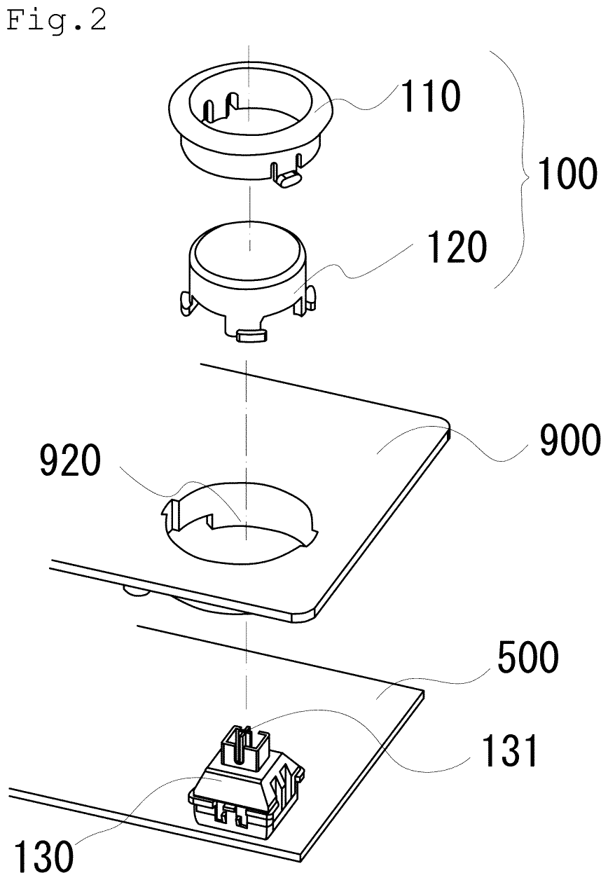

FIG. 2 is a schematic exploded view of the button 100 of the present Embodiment to illustrate the arrangement relationship of the components of the button 100. The button 100 includes a button member 120, a fixing ring 110, and a push switch 130.

The push switch 130 is fixed on the base plate 500, and the base plate 500 and housing 900 are fixed together by a screw.

The button member 120 is attached to the shaft 131 of the push switch 130 via the attachment hole 920 of the housing 900.

Furthermore, the fixing ring 110 is inserted into the attachment hole 920 on the housing 900 and rotated to the right to engage the housing 900 and attached so that the button member 120 will not come off the housing 900.

The details of the button member 120 and fixing ring 110 are described below. The structure of the present embodiment will then be explained.

### Fixing Ring 110

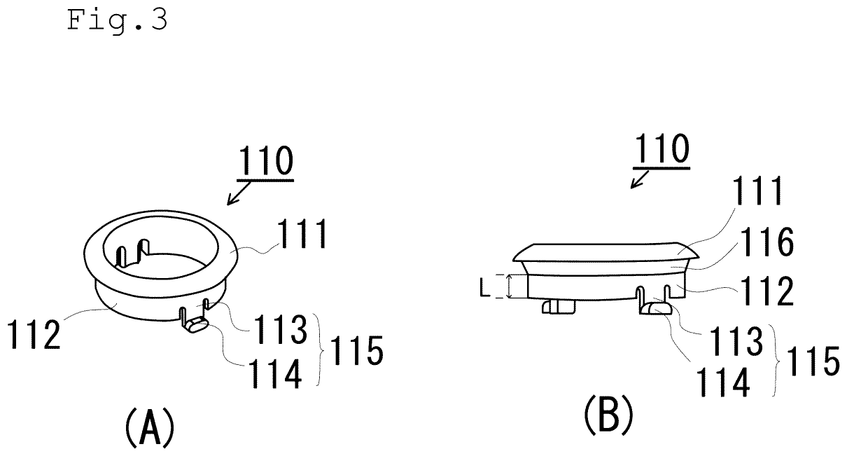

FIG. 3(A) is a schematic view to illustrate the shape of the fixing ring, and FIG. 3(B) is a schematic side view to illustrate the shape of the fixing ring.

As shown in FIG. 3, the fixing ring 110 is a component for fixing the button member 120 to the housing 900, and has a donut-shaped flange portion 111, a tapered portion 116 provided in a funnel shape adjacent to the flange portion 111, a cylinder-shaped skirt portion 112 that is extending from the tapered portion 116, and a projection 115 provided between slits of the skirt portion 112.

The projection 115 consists of an extending portion 113 and a protruding portion 114, and the protruding portion 114 of the projection 115 can be fitted into the housing 900 and fixed removably.

The flange portion 111 of the fixing ring 110 is shaped to slope gradually toward the top plate 910 of the housing when attached on the housing 900. The flange portion 111 is positioned on the top surface of the housing 900 and contacts the edge portion of the attachment hole 920 in the housing 900.

The tapered portion 116 of the fixing ring 110 is provided between the flange portion 111 and the skirt portion 112, and it is connected with an angle from the flange portion 111 to the skirt portion 112.

The skirt portion 112 of the fixing ring 110 is cylindrical shape, connected from the tapered portion 116, and has a predetermined length L. The button 100 of the present embodiment is provided with multiple types of fixing rings 110 that can be exchanged, and each fixing ring 110 is designed to have a different length L of the skirt portion 112. And the skirt portion length L of the fixing ring 110 is preferably between 2 mm and 10 mm.

The projection 115 of the fixing ring are shaped to protrude circumferentially from the skirt portion 112 at two opposing locations.

The fixing ring 110 has a cylindrical hole in the center, and the button member 120 is inserted into the hole.

The fixing ring in the present embodiment is made of resin. Although the present embodiment is made of resin, one or more of any material such as metal, PET, PP, POM, ABS, etc. may be used.

### Button Member 120

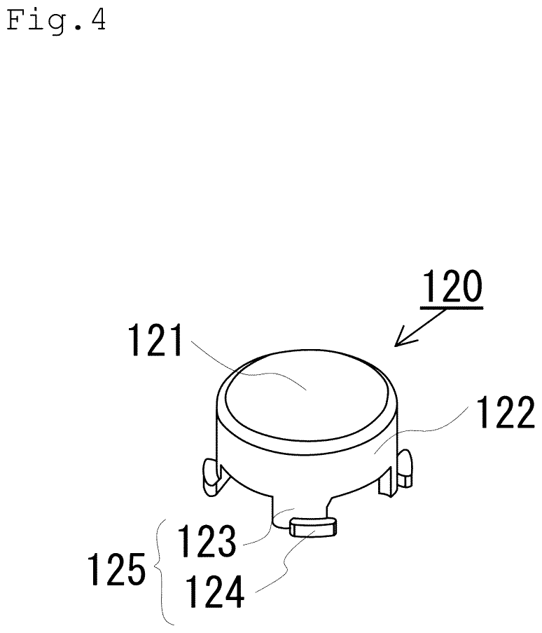

FIG. 4 is a schematic perspective view of the button member.

As shown in FIG. 4, the button member 120 is mainly cylindrical shape and comprise a pressing operation portion 121, which the user presses with a finger, a cylindrical cylinder portion 122 adjacent to the pressing operation portion 121, and a leg portion 125 extending from the cylinder portion 122. The leg portion 125 have an extending portion 123 and a protruding portion 124 that extends outward from the circumference.

The pressing operation portion 121 has a coupling portion on its underside for attaching to the shaft 131 of the push switch 130, and can transmit the user's pressing operation to the push switch 130.

The leg portion 125 can protect the push switch 130 and improve the stability of the push switch even when the user performs a vigorous pressing operation, the push switch is pressed and making contact with the base plate 500.

The button member 120 of the present embodiment is mainly made of resin. Among resins, it is preferable to use PBT, PP, PC, etc. for friction prevention or quietness, and it is more preferable to use silicone or fluoroplastic. This suppresses the impact sound and prevents noise even when buttons are repeatedly pressed in the home or at night.

The pressing operation portion 121 of the button member 120 is not limited to a circular shape, but may be square, oval, or cross-shaped.

The cylinder portion 122 of the button member 120 of the present embodiment has a cylindrical shape and adjacent to the pressing operation portion 121. The inner diameter of the cylinder portion 122 does not interfere with the push switch 130 when the pressing operation is performed, and the outer diameter of the cylinder portion 122 should be smaller than the inner diameter of the fixing ring 110.

The leg portion 125 of the button member 120 of the present embodiment is shaped to protrude from the cylinder portion 122 in four places outward from the circumference. The number of leg portion 125 of the button member 120 can be two or more, such as three or five, and it is preferable to have three or four. This can improve the stability of the pressing operation and prevent the structure in the housing 900 from being compressed.

The diameter of the pressing operation portion 121 of the button member 120 is preferably 10 mm or more and 40 mm or less, and more preferably 15 mm or more and 2 5mm or less.

### Combination of Each Component

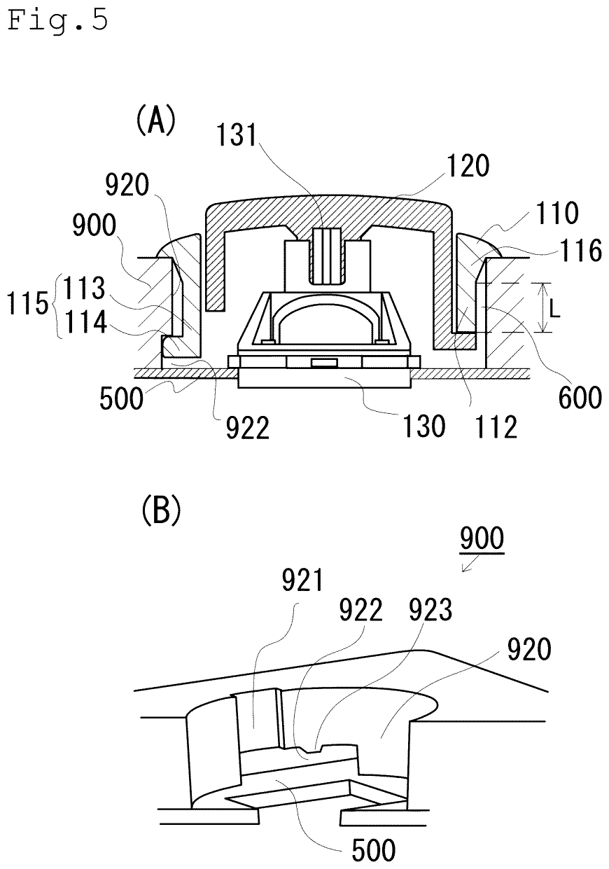

FIG. 5 is a schematic cross-sectional view to illustrate the state of the combined components of FIG. 2. FIG. 5(A) is a schematic partial cross-sectional view to illustrate the button 100, and FIG. 5(B) is a schematic partial cross-sectional view to illustrate the housing 900. FIG. 5(A) corresponds to the case where the button member 120 is released from pressing operation.

As shown in FIG. 5(A), the cylindrical tapered portion 116 of the fixing ring 110 has its entire circumference in contact with the corner of the attachment hole 920 of the housing 900, thereby the center of the fixing ring 110 and the center of the attachment hole 920 of the housing 900 are aligned for accurate positioning. This allows the clearance between the fixing ring 110 and the button member 120 to be minimized.

Furthermore, because the fixing ring 110 has a tapered portion 116, a space 600 can be provided between the attachment hole 920 of the housing 900 and the skirt portion 112 of the fixing ring 110. Therefore, the fixing ring 110 can be easily replaced because friction with the housing 900 is less likely to occur when the fixing ring 110 is removed and attached.

The projection 115 of the fixing ring 110 is fitted into the horizontal groove 922 provided inside the attachment hole 920 of the housing 900, thus allowing the fixing ring 110 to be fixed to the housing 900.

As shown in FIG. 5(B), the attachment hole 920 of the housing 900 has an insertion groove 921 formed in a vertical direction and a horizontal groove 922 formed horizontally on the bottom side of the housing 900. The projection 115 of the fixing ring 110 is guided vertically through the insertion groove 921, and further, by rotating the fixing ring 110, the projection 115 engages the horizontal groove 922.

The horizontal groove 922 in the present embodiment has a overhanging part 923, and by rotating the fixing ring 110, the projection 115 of the fixing ring 110 contacts the overhanging part 923, creating a frictional force. This prevents the fixing ring 110 from being inadvertently removed from the housing 900 even when the button 100 is operated vigorously.

### Pressing Operation and Stroke Width M

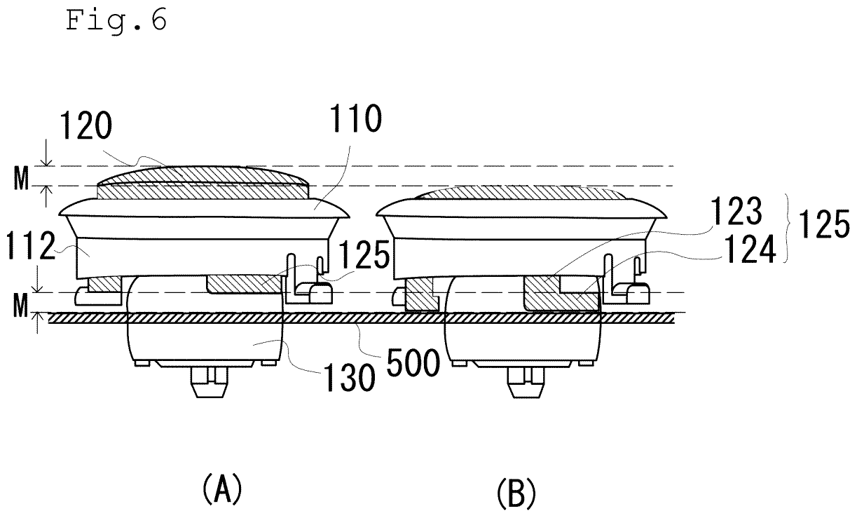

FIG. 6 is a schematic view of the case where the button member is released from pressing operation and the case where the button is pressed. FIG. 6(A) is a schematic view of the case where the button member is released from pressing operation, and FIG. 6(B) is a schematic view of the case where the button member is operated by pressing operation.

As shown in FIG. 6(A), when the button member 120 is released from pressing operation, the leg portion 125 of the button member 120 contact the skirt portion 112 of the fixing ring 110 by the spring force of the push switch 130.

As shown in FIG. 6(B), when the button member 120 is pressed operation, the leg portion 125 of the button member 120 contact the base plate 500 fixed to the housing 900.

Therefore, the distance between the lowest point of the skirt portion 112 of the fixing ring 110 and the top surface of the base plate 500, minus the thickness of the protruding portion 124 of the button member 120, is the stroke width M. In other words, as shown in FIG. 6 (A), the distance from the lowest point of the protruding portion 124 to the top surface of the base plate 500 is the distance the button member 120 is pushed when the pressing operation is performed, or stroke width M.

### Length L of Skirt Portion 112 and Stroke Width M

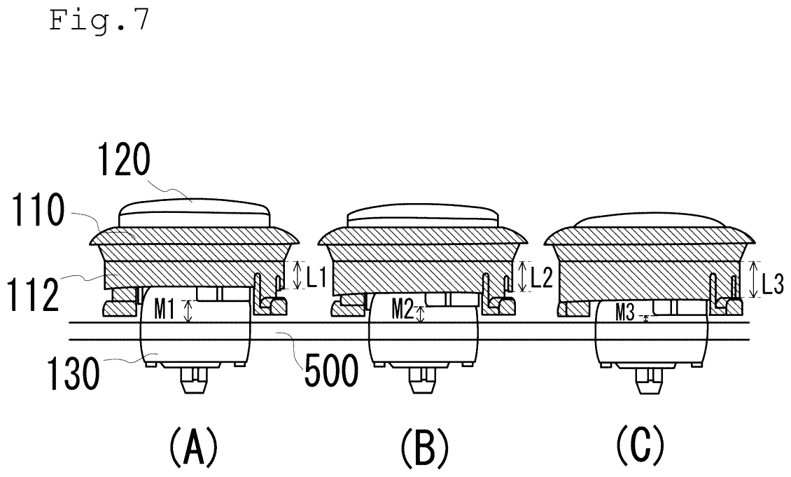

The button 100 of the present embodiment can adjust the stroke width M as desired by replacing the fixing ring 110. FIG. 7 is a schematic view of the relationship between the length L of the skirt portion 112 and the stroke width M.

In FIG. 7, buttons (A), (B), and (C) with fixing rings 110 with different lengths of skirt portions 112 are listed, with the length of the skirt portions 112 of buttons (A), (B), and (C) shown as L1, L2, and L3, respectively, and the stroke width M of buttons (A), (B), and (C) as M1, M2 and M3 are shown as M1, M2, and M3, respectively.

The button 100 equipped with a fixing ring 110 with a short skirt portion L1 has a longer stroke width M1. On the other hand, the button 100 equipped with a fixing ring 110 with a longer skirt portion L3 has a shorter stroke width M3.

Therefore, the stroke width of the button 100 can be easily adjusted by replacing the fixing ring 110 with a different length L of the skirt portion 112. In each fixing ring 110, the distance from the top of the skirt portion 112 to the extending portion 113 is the same.

### Adjustment of the Depth of the Reaction Point of Button 100

The present embodiment's controller for a game 10 is used, user may be desired to adjust not only the stroke, but also the depth of the reaction point when the button 100 is pressed, that is to say, user may be desired to adjust the pressing depth of the button 100 at which the digital output changes.

In particular, since the stroke width is changed by replacing the fixing ring 110 in the present embodiment controller for a game, if the reaction point is set at the midpoint of the stroke width, the fixing ring 110 with a large stroke width (the fixing ring 110 with a short skirt portion length) is replaced with a fixing ring 110 with a smaller stroke width, the reaction point may not be reached even if the button is released, and the switch may not function as a switch.

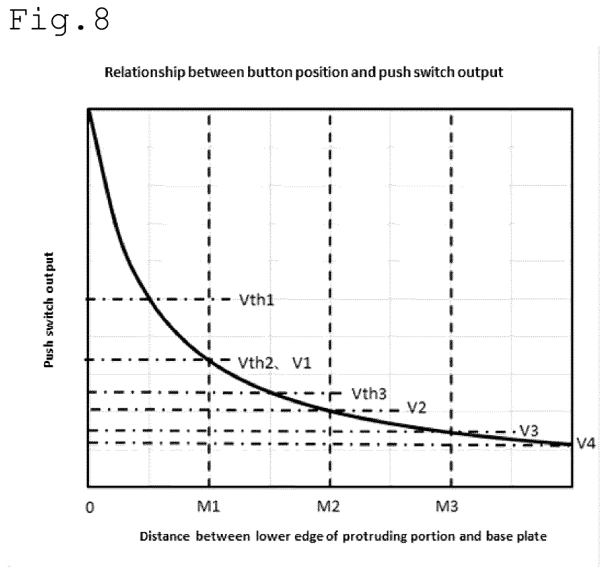

FIG. 8 shows an example of the relationship between the position of button 100 (more precisely, the distance between the lower edge of protruding portion 124 and base plate 500) and the push switch output. In FIG. 8, for a button with a stroke width M1, the button 100 moves between 0 and M1; for M2, it moves between 0 and M2; and for M3, it moves between 0 and M3. Although FIG. 8 shows three stroke options, it can be two or more than three. FIG. 8 also shows the output of the push switch at the midpoint of the stroke when the stroke width is M1 as Vth1, at the midpoint of the stroke when the stroke width is M2 as Vth2, and at the midpoint of the stroke when the stroke width is M3 as Vth3.

Three options are possible for how to set the output at the depth of the reaction point when the stroke width of the button 100 is changed.

The first method of setting the reaction point is to keep the depth of the reaction point of the button 100 constant even if the stroke width of the button 100 is changed. In this case, for example, by setting the reaction point as the point where the output of the push switch 130 becomes Vth1, the digital output can be switched stably even if the stroke width is changed between M1 and M3. However, in this case, when the stroke width is set to M3, the digital output will not switch unless the button 100 is pressed down quite deeply.

The second method of setting the reaction point is to always set the reaction point near the midpoint of the stroke when the stroke width of the button 100 is changed. In this case, if the stroke width is M1, the reaction point should be Vth1 in FIG. 8, if M2, Vth2, and if M3, Vth3. The specifics of the second setting method are described below.

The third method of setting the reaction point is for the user to select which position of the stroke is to be used as the reaction point. In this case, although it is difficult to set the setting by a game controller for a game 10 alone, the user can select it by installing a program for adjusting the depth of the reaction point in a personal computer or a game-specific device while the controller is connected to a personal computer or a game-specific device. For example, the user may be able to select from ¼, ½, or ¾ of a stroke for each button 100.

### A Specific Example of the Second Method of Setting

FIG. 8 shows the output of the push switch as V1 when the position of button 100 is M1, V2 when the position of button 100 is M2, and V3 when the position of button 100 is M3.

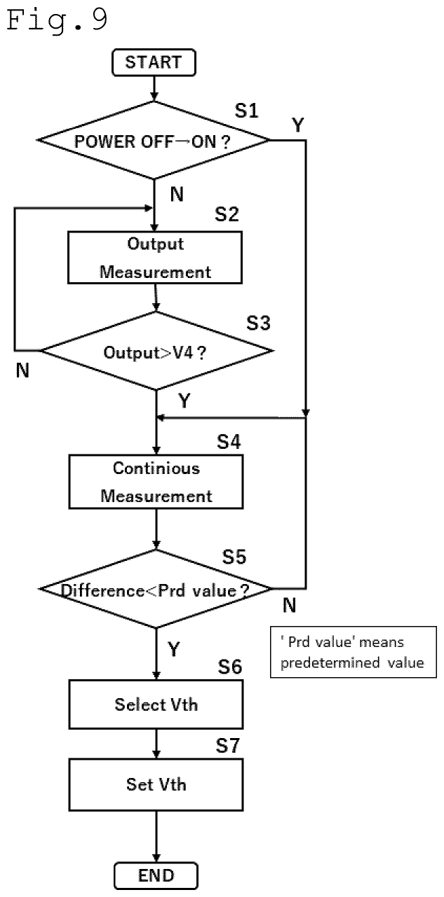

FIG. 9 shows an example of a flowchart of a program for adjusting the depth of the reaction point in the case of the second method of setting. This program is activated, for example, immediately after the USB power is turned on, if the fixing ring is replaced after the USB connector is disconnected. Or the program is activated if the fixing ring is replaced with the USB connector connected, when the pushing force against the push switch 130 is completely gone and the output is less than V4, which is smaller than V3 in FIG. 8. In other words, the system is activated when the output of the push switch 130 becomes equivalent to the output of the push switch 130 when the push force is completely lost. The program may also be activated by a long press of the button after the user has replaced the fixing ring.

The flowchart in FIG. 9 below describes the flow of the reaction point depth adjustment program.

(Step S1) Determine whether the power is turned ON from OFF, and if it is ON, start the switch output continuous measurement in Step 4.
(Steps S2 and S3) If the power is not turned ON from OFF, the output of the push switch 130 is measured, and the system waits until the output is greater than V4 in FIG. 8, that is, until the button member 120 is fixed to one of the fixing rings 110.
(Step S4) Measure and record the output of the push switch 30 continuously for a predetermined period of time. This recording may be done only for the maximum and minimum values of the output. This predetermined time is, for example, 10 seconds. For example, the average value of the voltage recorded in step S4 can be determined as the value of the release height of the button 100 with the fixing ring 110 attached.
(Step S5) The change in output, i.e., whether the difference between the maximum and minimum values is less than a predetermined value is checked, and if it is not less than a predetermined value (if the user performed a push operation during step S4), it returns to step S4 again. Step S5 is based on the idea that if the difference between the maximum and minimum values is less than a predetermined value (within the measurement error range), the measured output of push switch 130 is the output when button 100 is not pressed, on the assumption that the button 100 will not pressed continuously for 10 seconds, for example.
(Step S6) If the change in output is less than a predetermined value, the output value is checked to see which of V1, V2, and V3 in FIG. 8 is closest to the value.
(Step S7) If the output is close to V1, set Vth1, if close to V2, set Vth2, and if close to V3, set Vth3 as the threshold for digital output.

In the present invention, controller for a game 10 is equivalent to “controller”, housing 900 is equivalent to “housing”, push switch 130 is equivalent to “push switch”, button member 120 is equivalent to “button member”, fixing ring 110 is equivalent to “fixing ring”, base plate 500 is equivalent to “base plate”, leg portion 125 is equivalent to “leg portion”, skirt portion 112 is equivalent to “skirt portion”, tapered portion 116 is equivalent to “tapered portion”, attachment hole 920 is equivalent to “attachment hole”, and top plate 910 is equivalent to “top plate”.

A preferred embodiment of the present invention is as explained above. However, the present invention is not limited to only the embodiment. It would be understood that other various embodiments not departing from the spirit and the scope of the present invention can be made. Further, in the present embodiment, the action and the effects by the configuration of the present invention are explained. However, the action and the effects are examples and do not limit the present invention.

### REFERENCE SIGNS LIST

10 Controller for a game
100 button
110 Fixing ring
111 Flange portion
112 Skirt portion
113, 123 Extending portion
114, 124 Protruding portion
115 Projection
116 Tapered portion
120 Button member
121 Pressing operation portion
122 Cylinder portion
125 Leg portion
130 Push switch
131 Shaft
200 Control lever
300 Other control switches
400 USB cable
500 Base plate
600 Space
900 Housing
910 Top plate
920 Attachment hole
921 Insertion groove
922 Horizontal groove
923 protuberance part

1. A button which is used for a controller for a game, the button comprising:
a push switch built in a housing of the controller;
a button member connected to the push switch; and
a fixing ring supporting the button member,
wherein the fixing ring is removably provided to the housing, and
a stroke width of the button member can be adjusted through replacement of the fixing ring.

2. The button according to claim 1, wherein the button member has a leg portion which is brought into contact with a base plate fixed to the housing when a pressing operation is executed,
the fixing ring has a skirt portion which is brought into contact with the leg portion when the button member is released from the pressing operation, and
the stroke width of the button member can be adjusted through replacement of the fixing ring with a fixing ring having a different length of the skirt portion from a length of the skirt portion of the fixing ring.

3. The button according to claim 1, wherein the push switch is a depth sensor and a depth of a reaction point of the push switch can be adjusted.

4. The button according to claim 2, wherein the fixing ring has a tapered portion continuously provided to the skirt portion, and
the tapered portion abuts an edge portion of an attachment hole of the housing to which the fixing ring is fitted.

5. The button according to claim 1, wherein the button member has four leg portions.

6. A controller for a game comprising a button according to claim 1.

7. The controller for a game according to claim 6, wherein a plurality of the buttons are provided and a different depth of a reaction point can be set for each button.

8. The controller for a game according to claim 7, wherein a top plate of the housing is replaceable.
